(19) United States
(12) Patent Application Publication
(10) Pub. No.: US 2026/0008325 A1
(43) Pub. Date: Jan. 8, 2026

(54) MULTI-AXIS SUN VISOR

(71) Applicant: GM Global Technology Operations LLC, Detroit, MI (US)

(72) Inventors: Sungho Oh, Incheon (KR); Yong-Kyu Kim, Incheon (KR); Eunsuk Yang, Incheon (KR)

(73) Assignee: GM Global Technology Operations LLC, Detroit, MI (US)

(21) Appl. No.: 18/765,231

(22) Filed: Jul. 6, 2024

(51) Int. Cl. B60J 3/02

(52) U.S. Cl. CPC B60J 3/0226

(57) ABSTRACT

A sun visor assembly comprising a first arm coupled to a bracket and configured to rotate about a first axis and a second axis and a second arm coupled to the first arm with a hinge. A third axis extends through the second arm and a fourth axis extends through the hinge, the second arm being configured to rotate with respect to the first arm about the fourth axis. A visor is selectively coupled to the first arm and is rotatably coupled to the second arm, the visor being configured to rotate about the third axis.

### INTRODUCTION

The information provided in this section is for the purpose of generally presenting the context of the disclosure. Work of the presently named inventors, to the extent it is described in this section, as well as aspects of the description that may not otherwise qualify as prior art at the time of filing, are neither expressly nor impliedly admitted as prior art against the present disclosure.

The present disclosure relates generally to a sun visor and, more particularly, to an adjustable sun visor.

In general, vehicles can include one or more sun visors that are attached to a front portion of a vehicle ceiling. The sun visors can be used to prevent light from outside the vehicle from directly entering the eyes of occupants disposed in a passenger compartment of the vehicle. In some cases, the sun visors are arranged adjacent to a ceiling component that forms at least part of the vehicle ceiling. In such a case, the sun visors include a visor main body that is pivotal between a use position and a retracted position with respect to the ceiling component to allow vehicle passengers to only use the sun visors when required and remove the sun visors from a line-of-sight when not required.

Typically, the size of the sun visors depends on the size of the vehicle (i.e., small, medium, large) in which the sun visors are installed. Accordingly, numerous sizes of sun visors are required and, as a result, designing and installing different sun visors in a fleet of vehicles can be costly and challenging. Shortcomings of existing sun visors are addressed by one or more aspects of the present disclosure.

### SUMMARY

In one configuration, a sun visor assembly is provided and includes a bracket and a pivot arm. The pivot arm includes a first arm having a head at a first end that is movably coupled to the bracket and a second end opposite the first end of the first arm, and a second arm having a first end that is movably attached to the second end of the first arm and a second end spaced from the first end of the second arm. The second arm including an elongate portion extending between the first and second ends of the second arm. The sun visor further including a visor selectively coupled to the first arm and rotatably coupled to the second arm.

The sun visor may include one or more of the following aspects. For example, the bracket further includes a base and a socket coupled to the base. The socket can include a first opening and a second opening. A first axis can extend through the socket and the first arm can be configured to rotate about the first axis between the first opening and the second opening. A second axis can extend along the first arm and can be perpendicular to the first axis, the first arm being configured to rotate about the second axis. A third axis can extend between the first and second ends of the second arm and the visor can be configured to rotate about the third axis. A fourth axis can extend through a hinge that couples the second end of the first arm and the first end of the second arm, the second arm being configured to rotate with respect to the first arm about the fourth axis.

According to at least one aspect, the visor can have a front side and a rear side opposite the front side, the front side including a groove that is configured to retain a portion of the first arm. The sun visor assembly can include a first range of motion when the first arm is arranged in the groove. The sun visor assembly can include a second range of motion different than the first range of motion when the first arm is separated from the groove.

In another configuration, a vehicle is provided and includes a body including an interior, an exterior opposite the interior, one or more doors, and a roof. The vehicle further includes a sun visor assembly coupled to the body and including a bracket having a base and a socket coupled to the base, the socket having a first opening and a second opening. The sun visor assembly further including a first arm having a head at a first end that is movably coupled to the bracket and a second end opposite the first end of the first arm. A second arm has a first end that is movably attached to the second end of the first arm and a second end spaced from the first end of the second arm, the second arm having an elongate portion extending between the first and second ends of the second arm. The sun visor assembly further including a visor selectively coupled to the first arm and rotatably coupled to the second arm.

The vehicle may include one or more of the following optional aspects. For example, a first axis can extend through the socket and the first arm can be configured to rotate about the first axis between the first opening and the second opening. A second axis can extend along the first arm and can be perpendicular to the first axis, the first arm being configured to rotate about the second axis. A third axis can extend between the first and second ends of the second arm and the visor may be configured to rotate about the third axis. A fourth axis can extend through a hinge that couples the second end of the first arm and the first end of the second arm, the second arm being configured to rotate with respect to the first arm about the fourth axis.

In another configuration, a sun visor assembly is provided and includes a first arm coupled to a bracket and configured to rotate about a first axis and a second axis. A second arm is coupled to the first arm with a hinge, a third axis extends through the second arm, and a fourth axis extends through the hinge. The second arm is configured to rotate with respect to the first arm about the fourth axis. A visor is selectively coupled to the first arm and is rotatably coupled to the second arm, wherein the visor is configured to rotate about the third axis.

The sun visor assembly may include one or more of the following optional aspects. For example, the sun visor assembly further includes a first range of motion when the first arm is coupled to the first arm. The first range of motion includes rotation about the first axis and the second axis. The sun visor assembly further includes a second range of motion different than the first range of motion when the first arm is decoupled from the first arm. The second range of motion includes rotation about the first axis, the second axis, the third axis, and the fourth axis.

### BRIEF DESCRIPTION OF THE DRAWINGS

The drawings described herein are for illustrative purposes only of selected configurations and are not intended to limit the scope of the present disclosure.

FIG. 1 is a front perspective view of a vehicle according to principles of the present disclosure;

FIG. 2 is a perspective view of an interior of the vehicle of FIG. 1 including a sun visor in a position adjacent a windshield;

FIG. 3 is a perspective view of the interior of the vehicle including the sun visor of FIG. 2 in a position adjacent a driver side door;

FIG. 4 is a perspective view of a bracket including a socket according to principles of the present disclosure;

FIG. 5 is a perspective view of the bracket of FIG. 4 where a head of a first arm is arranged in the socket;

FIG. 6 is a perspective view of a sun visor assembly including the bracket of FIG. 4 and a pivot arm having the first arm and a second arm;

FIG. 7 is a close up perspective view of a hinge coupling the first arm and the second arm;

FIG. 8 is a rear view of the sun visor assembly with a visor arranged on the pivot arm in a first position;

FIG. 9 is a rear view of the sun visor assembly with the visor arranged on the pivot arm in a second position; and

FIG. 10 is a side view of the sun visor assembly with the visor arranged on the pivot arm in an extended position.

Corresponding reference numerals indicate corresponding parts throughout the drawings.

### DETAILED DESCRIPTION

Example configurations will now be described more fully with reference to the accompanying drawings. Example configurations are provided so that this disclosure will be thorough, and will fully convey the scope of the disclosure to those of ordinary skill in the art. Specific details are set forth such as examples of specific components, devices, and methods, to provide a thorough understanding of configurations of the present disclosure. It will be apparent to those of ordinary skill in the art that specific details need not be employed, that example configurations may be embodied in many different forms, and that the specific details and the example configurations should not be construed to limit the scope of the disclosure.

The terminology used herein is for the purpose of describing particular exemplary configurations only and is not intended to be limiting. As used herein, the singular articles “a,” “an,” and “the” may be intended to include the plural forms as well, unless the context clearly indicates otherwise. The terms “comprises,” “comprising,” “including,” and “having,” are inclusive and therefore specify the presence of features, steps, operations, elements, and/or components, but do not preclude the presence or addition of one or more other features, steps, operations, elements, components, and/or groups thereof. The method steps, processes, and operations described herein are not to be construed as necessarily requiring their performance in the particular order discussed or illustrated, unless specifically identified as an order of performance. Additional or alternative steps may be employed.

When an element or layer is referred to as being “on,” “engaged to,” “connected to,” “attached to,” or “coupled to” another element or layer, it may be directly on, engaged, connected, attached, or coupled to the other element or layer, or intervening elements or layers may be present. In contrast, when an element is referred to as being “directly on,” “directly engaged to,” “directly connected to,” “directly attached to,” or “directly coupled to” another element or layer, there may be no intervening elements or layers present. Other words used to describe the relationship between elements should be interpreted in a like fashion (e.g., “between” versus “directly between,” “adjacent” versus “directly adjacent,” etc.). As used herein, the term “and/or” includes any and all combinations of one or more of the associated listed items.

The terms “first,” “second,” “third,” etc. may be used herein to describe various elements, components, regions, layers and/or sections. These elements, components, regions, layers and/or sections should not be limited by these terms. These terms may be only used to distinguish one element, component, region, layer or section from another region, layer or section. Terms such as “first,” “second,” and other numerical terms do not imply a sequence or order unless clearly indicated by the context. Thus, a first element, component, region, layer or section discussed below could be termed a second element, component, region, layer or section without departing from the teachings of the example configurations.

In this application, including the definitions below, the term “module” may be replaced with the term “circuit.” The term “module” may refer to, be part of, or include an Application Specific Integrated Circuit (ASIC); a digital, analog, or mixed analog/digital discrete circuit; a digital, analog, or mixed analog/digital integrated circuit; a combinational logic circuit; a field programmable gate array (FPGA); a processor (shared, dedicated, or group) that executes code; memory (shared, dedicated, or group) that stores code executed by a processor; other suitable hardware components that provide the described functionality; or a combination of some or all of the above, such as in a system-on-chip.

The term “code,” as used above, may include software, firmware, and/or microcode, and may refer to programs, routines, functions, classes, and/or objects. The term “shared processor” encompasses a single processor that executes some or all code from multiple modules. The term “group processor” encompasses a processor that, in combination with additional processors, executes some or all code from one or more modules. The term “shared memory” encompasses a single memory that stores some or all code from multiple modules. The term “group memory” encompasses a memory that, in combination with additional memories, stores some or all code from one or more modules. The term “memory” may be a subset of the term “computer-readable medium.” The term “computer-readable medium” does not encompass transitory electrical and electromagnetic signals propagating through a medium, and may therefore be considered tangible and non-transitory memory. Non-limiting examples of a non-transitory memory include a tangible computer readable medium including a nonvolatile memory, magnetic storage, and optical storage.

The apparatuses and methods described in this application may be partially or fully implemented by one or more computer programs executed by one or more processors. The computer programs include processor-executable instructions that are stored on at least one non-transitory tangible computer readable medium. The computer programs may also include and/or rely on stored data.

A software application (i.e., a software resource) may refer to computer software that causes a computing device to perform a task. In some examples, a software application may be referred to as an “application,” an “app,” or a “program.” Example applications include, but are not limited to, system diagnostic applications, system management applications, system maintenance applications, word processing applications, spreadsheet applications, messaging applications, media streaming applications, social networking applications, and gaming applications.

The non-transitory memory may be physical devices used to store programs (e.g., sequences of instructions) or data (e.g., program state information) on a temporary or permanent basis for use by a computing device. The non-transitory memory may be volatile and/or non-volatile addressable semiconductor memory. Examples of non-volatile memory include, but are not limited to, flash memory and read-only memory (ROM)/programmable read-only memory (PROM)/erasable programmable read-only memory (EPROM)/electronically erasable programmable read-only memory (EEPROM) (e.g., typically used for firmware, such as boot programs). Examples of volatile memory include, but are not limited to, random access memory (RAM), dynamic random access memory (DRAM), static random access memory (SRAM), phase change memory (PCM) as well as disks or tapes.

These computer programs (also known as programs, software, software applications or code) include machine instructions for a programmable processor, and can be implemented in a high-level procedural and/or object-oriented programming language, and/or in assembly/machine language. As used herein, the terms “machine-readable medium” and “computer-readable medium” refer to any computer program product, non-transitory computer readable medium, apparatus and/or device (e.g., magnetic discs, optical disks, memory, Programmable Logic Devices (PLDs)) used to provide machine instructions and/or data to a programmable processor, including a machine-readable medium that receives machine instructions as a machine-readable signal. The term “machine-readable signal” refers to any signal used to provide machine instructions and/or data to a programmable processor.

Various implementations of the systems and techniques described herein can be realized in digital electronic and/or optical circuitry, integrated circuitry, specially designed ASICS (application specific integrated circuits), computer hardware, firmware, software, and/or combinations thereof. These various implementations can include implementation in one or more computer programs that are executable and/or interpretable on a programmable system including at least one programmable processor, which may be special or general purpose, coupled to receive data and instructions from, and to transmit data and instructions to, a storage system, at least one input device, and at least one output device.

The processes and logic flows described in this specification can be performed by one or more programmable processors, also referred to as data processing hardware, executing one or more computer programs to perform functions by operating on input data and generating output. The processes and logic flows can also be performed by special purpose logic circuitry, e.g., an FPGA (field programmable gate array) or an ASIC (application specific integrated circuit). Processors suitable for the execution of a computer program include, by way of example, both general and special purpose microprocessors, and any one or more processors of any kind of digital computer. Generally, a processor will receive instructions and data from a read only memory or a random access memory or both. The essential elements of a computer are a processor for performing instructions and one or more memory devices for storing instructions and data. Generally, a computer will also include, or be operatively coupled to receive data from or transfer data to, or both, one or more mass storage devices for storing data, e.g., magnetic, magneto optical disks, or optical disks. However, a computer need not have such devices. Computer readable media suitable for storing computer program instructions and data include all forms of non-volatile memory, media and memory devices, including by way of example semiconductor memory devices, e.g., EPROM, EEPROM, and flash memory devices; magnetic disks, e.g., internal hard disks or removable disks; magneto optical disks; and CD ROM and DVD-ROM disks. The processor and the memory can be supplemented by, or incorporated in, special purpose logic circuitry.

To provide for interaction with a user, one or more aspects of the disclosure can be implemented on a computer having a display device, e.g., a CRT (cathode ray tube), LCD (liquid crystal display) monitor, or touch screen for displaying information to the user and optionally a keyboard and a pointing device, e.g., a mouse or a trackball, by which the user can provide input to the computer. Other kinds of devices can be used to provide interaction with a user as well; for example, feedback provided to the user can be any form of sensory feedback, e.g., visual feedback, auditory feedback, or tactile feedback; and input from the user can be received in any form, including acoustic, speech, or tactile input. In addition, a computer can interact with a user by sending documents to and receiving documents from a device that is used by the user; for example, by sending web pages to a web browser on a user's client device in response to requests received from the web browser.

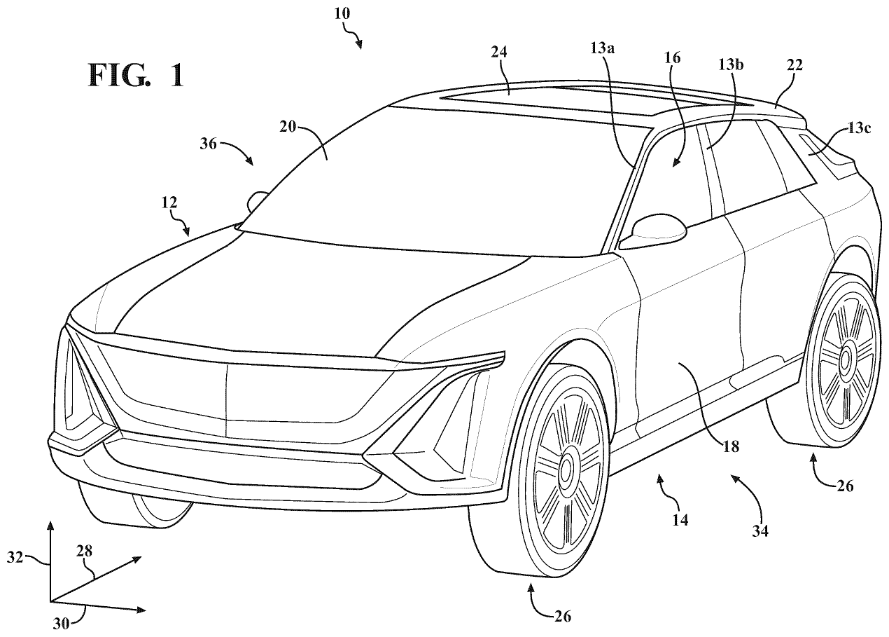

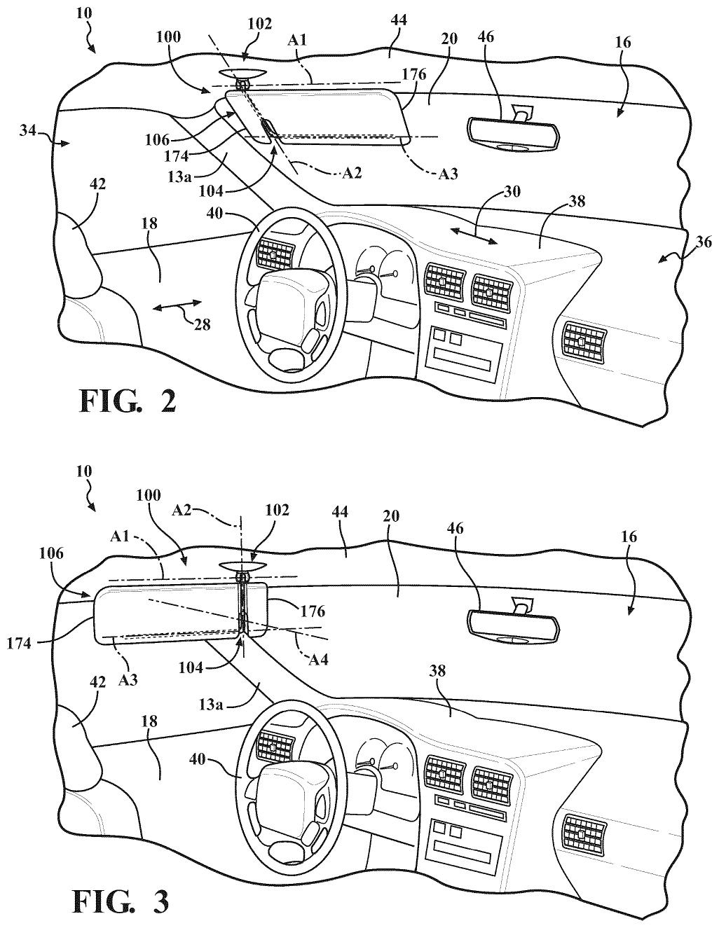

With reference to FIG. 1, a vehicle 10 is provided. The vehicle 10 includes a vehicle body 12 that defines an exterior 14 and an interior 16 (FIG. 2). The vehicle body 12 can include one or more pillars 13, such as an A-pillar 13a, a B-pillar 13b, and a C-pillar 13c. The vehicle body 12 can include one or more closures, such as a one or more doors (e.g., a driver side door 18), a windshield 20, a roof 22, and a sunroof 24 arranged in the roof 22, for example. Additionally, one or more wheels 26 are coupled to the vehicle body 12. The vehicle body 12 extends along a longitudinal axis (i.e., fore-aft direction) 28, a lateral axis (i.e., cross-car direction) 30, and a vertical axis 32.

With reference to FIG. 2, the interior 16 of the vehicle 10 can include a first or driver side 34 and a second or passenger side 36. In the present disclosure, the driver side 34 is on a left side of the vehicle 10 and the passenger side 36 is on a right side of the vehicle 10. Note, the driver side 34 may be on the right side of the vehicle 10 and the passenger side 36 may be on the left side of the vehicle 10 depending on in what region of the world the vehicle 10 is manufactured. Nonetheless, the disclosure equally applies to all vehicles regardless of the location of the driver side 34 and the passenger side 36. The interior 16 of the vehicle 10 can also include an instrument panel 38 and a steering wheel 40 extending from the instrument panel 38. A driver seat 42 can be arranged fore-aft of the steering wheel 40 with respect to the longitudinal axis 28. A roof panel or headliner 44 can be coupled to an interior portion of the roof 22 (FIG. 1). Also, a rear view mirror 46 can be coupled to the windshield 20 and arranged cross-car between the driver side 34 and the passenger side 36 with respect to the lateral axis 30.

With continued reference to FIG. 2, the interior of the vehicle 10 includes a sun visor assembly 100. In the present illustrative example, the sun visor assembly 100 is arranged on and discussed with respect to the driver side 34 of the vehicle 10. However, the sun visor assembly 100 is not limited to such an arrangement and can be coupled to or arranged in other areas within the interior 16 of the vehicle 10.

The sun visor assembly 100 includes a bracket 102, a pivot arm 104 coupled to the bracket 102, and a visor 106 coupled to the pivot arm 104. In general, the sun visor assembly 100 can be configured so that an original equipment manufacturer does not need to produce a variety of sun visors to accommodate different sized vehicles (e.g., small, medium, and large). In other words, the sun visor assembly 100 is configured to be arranged in different types of vehicles (e.g., sport utility vehicles (SUV), sedans, trucks, etc.) and is adjustable by a user (e.g., a driver or passenger) to block light from entering into the interior 16 of the vehicle 10.

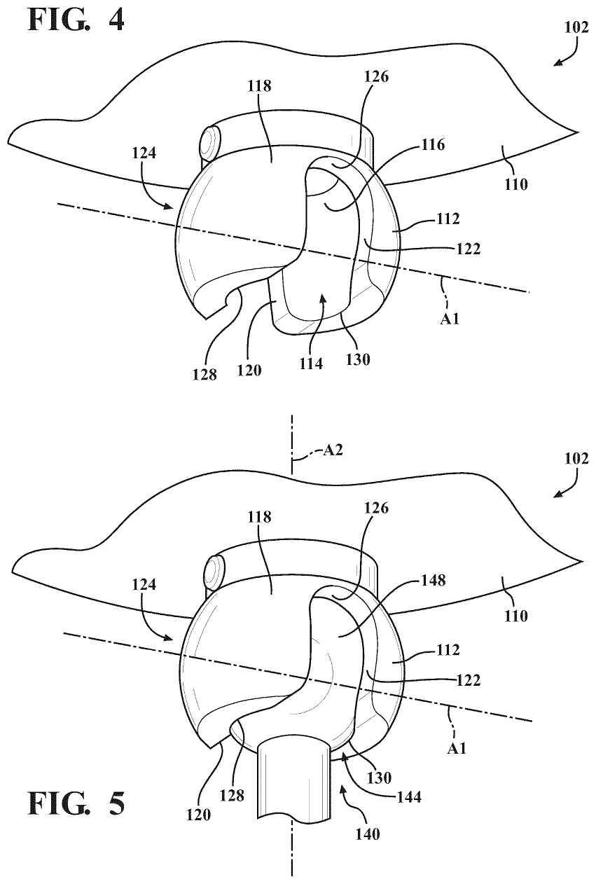

With reference to FIGS. 4 and 5, the bracket 102 includes a base 110 that is configured to be coupled to the headliner 44 and/or a portion of the roof 22 within the interior 16 of the vehicle 10. In the present illustrative example, as shown in FIGS. 2 and 3, the base 110 can be arranged cross-car of the A-pillar 13a with respect to the lateral axis 30 and fore-aft of the windshield 20 with respect to the longitudinal axis 28. In other words, the base 110 can be coupled the headliner 44 and/or the roof 22 between the driver side door 18 and the rear view mirror 46, for example. With reference to FIG. 4, a socket 112 is coupled to the base 110 and projects into the interior 16 of the vehicle 10. The socket 112 includes a chamber 114 that has an interior surface 116 and an exterior surface 118. The interior surface 116 can have a concave interior surface and the exterior surface 118 can have a convex outer surface, for example. In another configuration, the exterior surface 118 can be a cube or have a shape that does not resemble the shape of the interior surface 116. With continued reference to FIGS. 2 and 4, a first axis A1 extends cross-car through the socket 112. The first axis A1 can be parallel to the lateral axis 30. Additionally, a second axis A2 extends through a central portion of the socket 112, as shown in FIG. 5. The second axis A2 can be parallel to the vertical axis 32 or angled with respect to the vertical axis 32. One or more openings can be arranged perpendicular to the first axis A1 and through a portion of the socket 112, as shown in FIG. 4. For instance, a first opening 120 can face the windshield 20 in the fore-aft direction and a second opening 122 can be spaced fore-aft of the first opening 120 and face away from the windshield 20. The first opening 120 has a first upper edge 124 and the second opening 122 has a second upper edge 126. The socket 112 also has a first bottom edge 128 that extends between the first opening 120 and the second opening 122 and a second bottom edge 130 that is spaced cross-car from the first bottom edge 128 and extends between the first opening 120 and the second opening 122.

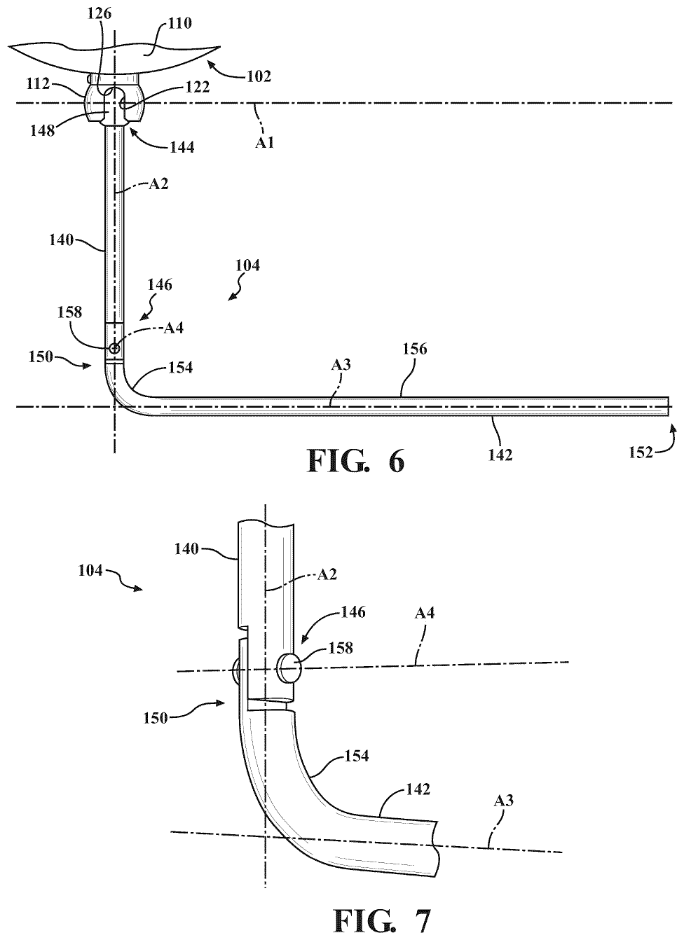

With reference to FIG. 6, the pivot arm 104 is arranged with respect to the bracket 102. The pivot arm 104 includes a first arm 140 movably coupled to the bracket 102 and a second arm 142 that is movably (e.g., hingedly) coupled to the first arm 140. In general, the first and second arms 140, 142 can have a cylindrical shape and the first arm 140 has a first length and the second arm 142 has a second length. According to one aspect, the length of the second arm 142 is greater than the length of the first arm 140. In the present illustrative example, the first arm 140 includes a first end 144 and a second end 146 spaced axially from the first end 144. A head or ball 148 is coupled to the first end 144 and can be movably coupled within the chamber 114 of the socket 112, as shown in FIG. 5. The first arm 140 can rotate about the first axis A1 between the first upper edge 124 of the first opening 120 and the second upper edge 126 of the second opening 122. In other words, a portion of the first arm 140 between the first end 144 and the second end 146 can move fore-aft toward the windshield 20 or away from the windshield 20. In the present illustrative example, lateral rotation of the first arm 140 is limited by the first bottom edge 128 and the second bottom edge 130. However, in other configurations, additional openings in the socket 112 may allow for such rotation so that a portion of the first arm 140 can move cross-car as a well. Additionally, as will be discussed below, the first arm 140 can be configured to rotate clockwise and counterclockwise about the second axis A2. With reference again to FIG. 6, the second arm 142 includes a first end 150 and a second end 152 spaced from the first end 150 with respect to the lateral axis 30. The second arm 142 can include a bend (e.g., a 90-degree bend) 154 at the first end 150 and an elongate portion 156 between the bend 154 and the second end 152, as shown in FIG. 6. A third axis A3 extends through the elongate portion 156 from the first end 150 to the second end 152. The second end 146 of the first arm 140 can be coupled to the first end 150 of the second arm 142 with a hinge 158. A fourth axis A4 can extend through the hinge 158 with respect to the longitudinal axis 28, as shown in FIG. 7. According to one aspect, the elongate portion 156 can act as a moment arm so a user (e.g., driver or passenger) can easily rotate the pivot arm 104 and, more particularly, the first arm 140 about the second axis A2. Additionally, as will be discussed in more detail below, the elongate portion 156 can also act as a hinge for the visor 106.

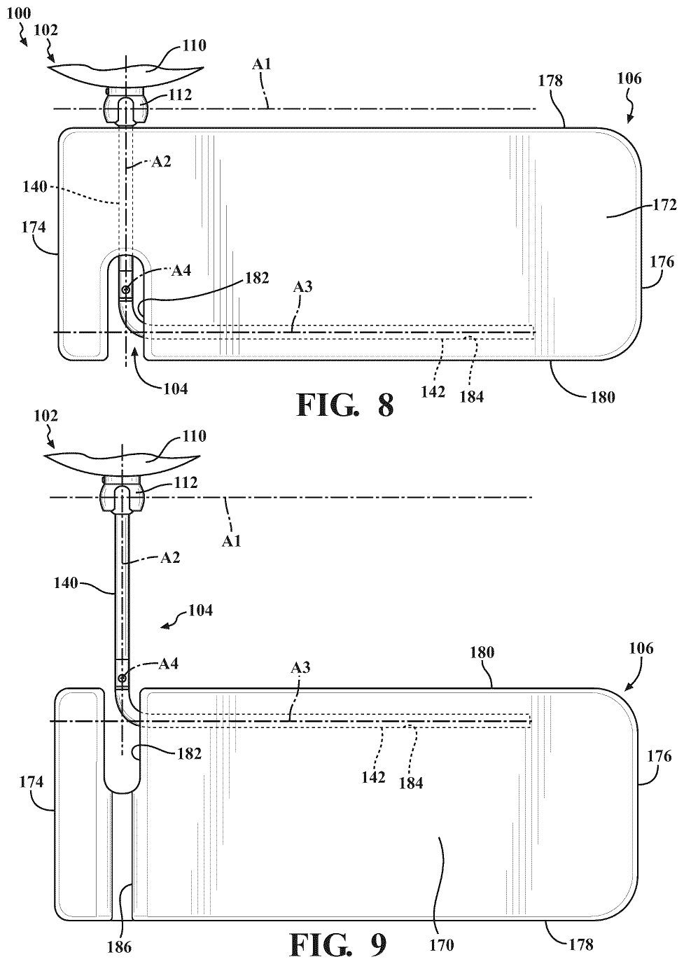

With reference to FIGS. 8 and 9, the visor 106 is shown arranged on a portion of the pivot arm 104. The visor 106 includes a first or front side 170 (FIG. 9), a second or rear side 172 (FIG. 8) opposite the front side 170, and a thickness between the front side 170 and the rear side 172. The visor 106 also includes a third or left side 174, a fourth or right side 176 opposite the left side 174, a fifth or upper side 178, and a sixth or lower side 180 opposite the upper side 178. An opening 182 is arranged adjacent the left side 174 and extends through a portion of the front side 170 and the rear side 172. The visor 106 includes a channel 184 that extends from the opening 182 between the front side 170 and the rear side 172 toward the right side 176. The channel 184 can be configured to receive a portion of the second arm 142 so that a user can rotate the visor 106 about the third axis A3, for example. The front side 170 also includes a groove 186 that extends from the opening 182 to the upper side 178, as shown in FIG. 9. The groove 186 can be configured to receive and retain a portion of the first arm 140 when the visor 106 is arranged in a first position (FIG. 8) so that the visor 106 cannot freely rotate about the third axis A3, for example. The groove 186 can also be configured so that a user can easily decouple the first arm 140 from the groove 186 to a second position. When the visor 106 is decoupled (i.e., not coupled to) from the groove 186, the visor can be rotated about the third axis A3 and the fourth axis A4, for example.

With reference to FIGS. 2 and 3, the sun visor assembly 100 has a first range of motion when the first arm 140 (FIG. 8) is coupled to the groove 186 (FIG. 9) of the visor 106. In the present illustrative example, the first range of motion includes rotation of at least a portion of the visor assembly 100 about the first axis A1 and/or the second axis A2. A user can grip a portion of the visor 106 and adjust the visor 106 toward or away from the windshield 20 about the first axis A1. Additionally or alternatively, a user can adjust the visor 106 about the second axis A2 from a position that is adjacent the windshield 20, as shown in FIG. 2, to another position that is adjacent the driver side door 18, as shown in FIG. 3.

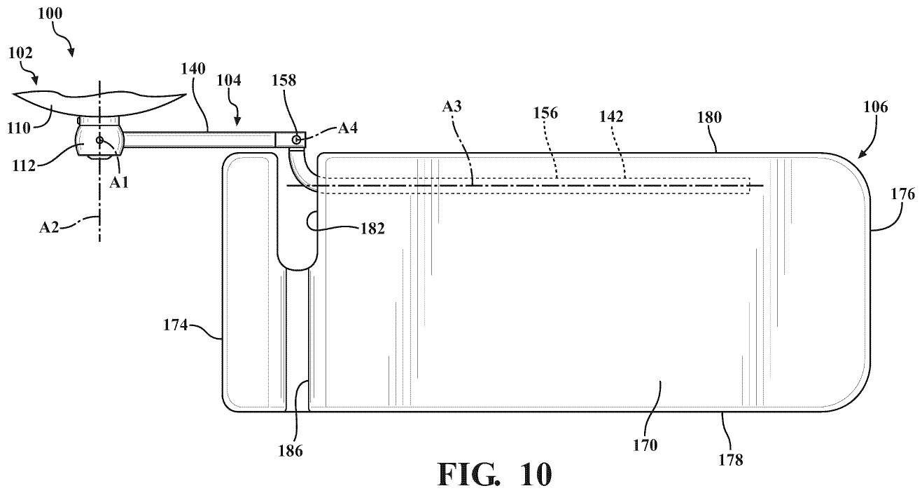

With reference to FIGS. 9 and 10, the sun visor assembly 100 has a second range of motion different than the first range of motion when the first arm 140 is decoupled (i.e., not coupled to) from the groove 186 of the visor 106. In the present illustrative example, the second range of motion includes rotation of at least a portion of the sun visor assembly 100 about the first axis A1, the second axis A2, the third axis A3, and/or the fourth axis A4. With reference to FIG. 9, a user can grip the visor 106 and adjust the visor 106 about the third axis A3. This may be desirable to change the vertical position of the visor 106 with respect to the roof 22 and/or headliner 44, for example. Additionally or alternatively, when the visor 106 is not coupled to the first arm 140 and is arranged adjacent the driver side door 18, a user can further adjust the visor 106 in the fore-aft direction with respect to the longitudinal axis 28. In other words, a user can grip a portion of the visor 106 and adjust the position of the second arm 142 with respect to the first arm 140. As shown in FIG. 10, the first arm 140 can be arranged so that the first arm 140 is generally parallel to the second arm 142. Adjusting the sun visor assembly 100 in this manner may be desirable so that a user can block light entering the interior 16 of the vehicle 10 from a window of the driver side door 18, for example.

A number of implementations have been described. Nevertheless, it will be understood that various modifications may be made without departing from the spirit and scope of the disclosure. Accordingly, other implementations are within the scope of the following claims.

The foregoing description has been provided for purposes of illustration and description. It is not intended to be exhaustive or to limit the disclosure. Individual elements or features of a particular configuration are generally not limited to that particular configuration, but, where applicable, are interchangeable and can be used in a selected configuration, even if not specifically shown or described. The same may also be varied in many ways. Such variations are not to be regarded as a departure from the disclosure, and all such modifications are intended to be included within the scope of the disclosure.

What is claimed is:

1. A sun visor assembly comprising:
a bracket;
a pivot arm, comprising:
a first arm having a head at a first end that is movably coupled to the bracket and a second end opposite the first end of the first arm, and
a second arm having a first end that is movably attached to the second end of the first arm and a second end spaced from the first end of the second arm, the second arm having an elongate portion extending between the first and second ends of the second arm; and
a visor selectively coupled to the first arm and rotatably coupled to the second arm.

2. The sun visor assembly of claim 1, wherein the bracket further comprises a base and a socket coupled to the base.

3. The sun visor assembly of claim 2, wherein the socket includes a first opening and a second opening.

4. The sun visor assembly of claim 3, wherein a first axis extends through the socket, the first arm being configured to rotate about the first axis between the first opening and the second opening.

5. The sun visor assembly of claim 4, wherein a second axis extends along the first arm and is perpendicular to the first axis, the first arm being configured rotate about the second axis.

6. The sun visor assembly of claim 5, wherein a third axis extends between the first and second ends of the second arm, the visor being configured to rotate about the third axis.

7. The sun visor assembly of claim 6, wherein a fourth axis extends through a hinge that couples the second end of the first arm and the first end of the second arm, the second arm being configured to rotate with respect to the first arm about the fourth axis.

8. The sun visor assembly of claim 1, wherein the visor has a front side and a rear side opposite the front side, the front side including a groove that is configured to retain a portion of the first arm.

9. The sun visor assembly of claim 8, wherein the visor includes a first range of motion when the first arm is arranged in the groove.

10. The sun visor assembly of claim 9, wherein the visor includes a second range of motion different than the first range of motion when the first arm is separated from the groove.

11. A vehicle comprising:
a body comprising:
an interior,
an exterior opposite the interior,
one or more doors, and
a roof; and
a sun visor assembly coupled to the body, the sun visor assembly comprising:
a bracket having a base and a socket coupled to the base, the socket having a first opening and a second opening,
a first arm having a head at a first end that is movably coupled to the bracket and a second end opposite the first end of the first arm, and
a second arm having a first end that is movably attached to the second end of the first arm and a second end spaced from the first end of the second arm, the second arm having an elongate portion extending between the first and second ends of the second arm, and
a visor selectively coupled to the first arm and rotatably coupled to the second arm.

12. The vehicle of claim 11, wherein a first axis extends through the socket, the first arm being configured to rotate about the first axis between the first opening and the second opening.

13. The vehicle of claim 12, wherein a second axis extends along the first arm and is perpendicular to the first axis, the first arm being configured to rotate about the second axis.

14. The vehicle of claim 13, wherein a third axis extends between the first and second ends of the second arm, the visor being configured to rotate about the third axis.

15. The vehicle of claim 14, wherein a fourth axis extends through a hinge that couples the second end of the first arm and the first end of the second arm, the second arm being configured to rotate with respect to the first arm about the fourth axis.

16. A sun visor assembly comprising:
a first arm coupled to a bracket and configured to rotate about a first axis and a second axis;
a second arm coupled to the first arm with a hinge, a third axis extends through the second arm and a fourth axis extends through the hinge, the second arm being configured to rotate with respect to the first arm about the fourth axis; and
a visor selectively coupled to the first arm and rotatably coupled to the second arm, the visor being configured to rotate about the third axis.

17. The sun visor assembly of claim 16, wherein the visor includes a first range of motion when the visor is coupled to the first arm.

18. The sun visor assembly of claim 17, wherein the first range of motion comprises rotation about the first axis and the second axis.

19. The sun visor assembly of claim 18, wherein the visor includes a second range of motion different than the first range of motion when the visor is decoupled from the first arm.

20. The sun visor assembly of claim 19, wherein the second range of motion comprises rotation about the first axis, the second axis, the third axis, and the fourth axis.
